(19) United States
(12) Patent Application Publication
(10) Pub. No.: US 2017/0270397 A1
(43) Pub. Date: Sep. 21, 2017

(54) Data Carrier Comprising a Partial Piece

(71) Applicant: GIESECKE & DEVRIENT GMBH, München (DE)

(72) Inventor: Markus SEXL, Baierbrunn (DE)

(21) Appl. No.: 15/505,297

(22) PCT Filed: Aug. 17, 2015
(86) PCT No.: PCT/EP2015/001696

§ 371 Date: Feb. 21, 2017

(30) Foreign Application Priority Data
Aug. 21, 2014 (DE) 10 2014 012 394.4

(51) Int. Cl. G06K 19/077

(52) U.S. Cl. CPC G06K 19/0772; G06K 19/07739

(57) ABSTRACT

In a method for manufacturing a data carrier with a partial piece, in particular a chip card, a thickness of the data carrier body is reduced in a predetermined region on the front side of the data carrier body and the data carrier body is cut through in the predetermined region in order to produce the partial piece. The partial piece is fitted into a through opening of the data carrier body created by the cutting through, and is displaced in the through opening in the direction of the front side of the data carrier body such that the partial piece is flush with the front side of the data carrier body.

The present invention relates to a method for manufacturing a data carrier with a partial piece detachable therefrom, and such a data carrier, in particular a chip card, preferably a so-called combined SIM card.

Chip cards of various sizes are known, in particular in the form of SIM cards for mobile communication terminals. The different sizes of SIM cards are known in particular as mini SIM (“2FF”, second form factor), micro SIM (“3FF” third form factor) and nano SIM (“4FF”, fourth form factor) and are employed for different types of mobile phones, for example. A user of a mobile phone receives a SIM card matching his mobile phone most frequently in the form of a partial piece of a chip card in the credit card format (ID-1) for breaking out. In order to simplify the manufacture and handling, combined SIM cards are known, wherein several of the mentioned form factors are pre-punched in a card body for breaking out or pushing out.

In addition to different length and width dimensions, the different form factors can also have different thicknesses. When, for example, a nano SIM is to be made available in a combined SIM, there is the problem that the nano SIM has a smaller thickness according to its specification than the other form factors. The smaller thickness can be achieved by milling the front side of the chip card, since a cavity needs to be milled here anyway for receiving a chip module. However, when in such a combined SIM it is not the nano SIM that is required, but a larger form factor, the contact areas of the chip module are disposed in a depression on the front side of the card. This can result in the contacts of the mobile phone becoming stuck in the depression. When, in order to avoid a depression on the front side, the thickness of the card body is reduced from the back side, for example by milling, the already printed back side is destroyed in this region or the not yet printed card body cannot be printed properly in this region.

It is the object of the present invention to propose a data carrier with a partial piece of reduced thickness and a method for its manufacture, wherein the handling and manufacture of the data carrier are improved with reference to the disadvantages mentioned above.

This object is achieved by a method for manufacturing a data carrier and a data carrier having the features of the independent claims. Advantageous embodiments and further developments are specified in the dependent claims.

In a method for manufacturing a data carrier, in particular a chip card, a card-shaped data carrier body is first made available, having a first thickness and a front side and a back side. The first thickness is reduced to a second thickness in a predetermined region on the front side of the data carrier body, which can be effected by removing material, for example by milling, of the front side in the predetermined region. The back side and optionally the front side of the data carrier body can be printed either before or after reducing the thickness.

For producing a first, detachable partial piece, the data carrier body is cut through in the predetermined region, so that the first partial piece is fitted into a through opening of the data carrier body formed by the cutting and can be displaced in the through opening. The cutting through of the data carrier body is effected within the predetermined region, but can preferably be effected exactly along the edges, so that the predetermined region has the same length and width dimensions as the first partial piece to be produced. Alternatively, it is possible conversely to effect the cutting through of the data carrier body first and then the reduction of the thickness of the data carrier body consecutively.

The first partial piece is then so displaced within the through opening in the direction of the front side of the data carrier body that the first partial piece is flush with the front side of the data carrier body. Since the first partial piece is arranged in the through opening of the data carrier body such that it is flush with the front side of the data carrier body, the resulting data carrier has a level front side and a depression in the region of the first partial piece on the back side. The level front side is advantageous in comparison to a depression on the front side, since contacts of a mobile communication terminal can slide over the front side of the data carrier, on which there are preferably disposed contact areas of a chip module, without there existing the risk that they will get stuck in a depression. However, since the thickness of the data carrier in the predetermined region is not reduced from the back side, but from the front side with subsequent displacement of the first partial piece in the direction of the front side, the print of the back side is not destroyed.

Preferably, the method comprises the step of printing at least the back side and/or the front side of the data carrier body at a time before reducing the thickness of the data carrier body in the predetermined region. As mentioned, the print on the back side is not destroyed, since the reduction of the thickness is effected from the front side. Destroying the print in the predetermined region on the front side is undisturbing, however, since in this place there is advantageously implanted a chip module in the data carrier body anyway, which chip module can cover the area of the first partial piece completely or, if the contact areas are smaller than the area of the first partial piece, then there is merely a small border around the contact areas of the chip module without print.

Preferably, the cutting through of the data carrier body for producing the first partial piece is effected from the front side of the data carrier body. This is preferably done by means of a special punching tool and a punch which is adapted to hold the produced partial piece in the punched through opening upon withdrawal of the punching knife and to push said partial piece in the direction of the front side of the data carrier body. Thus, the first partial piece can be produced and displaced in one step.

Preferably, the data carrier comprises a chip module which is inserted into the first partial piece. Accordingly, the manufacturing method preferably further comprises the steps of producing a cavity for a chip module on the front side of the data carrier body in the predetermined region and of inserting a chip module in the cavity. This is preferably effected before the displacement of the first partial piece in the direction of the front side of the data carrier body. In other words, the first partial piece is moved in the through opening of the data carrier body together with the implanted chip module, whereby it is achieved in particular that the contact areas of the chip module are flush with the front side of the data carrier. The contact areas can take up the surface of the first partial piece completely or cover only part thereof.

In a preferred exemplary embodiment, the original, first thickness of the data carrier body in the predetermined region is reduced by a proportion of at most 30%, preferably between 15% and 25%. In other words, the second thickness amounts to at least 70%, preferably between 75% and 85% of the first thickness.

Preferably, in addition to the first partial piece, a second and/or a third partial piece detachable from the data carrier body are produced, wherein advantageously the second partial piece encloses the first partial piece and the third partial piece encloses the first and, where applicable, second partial piece. Preferably, the second partial piece has a length of 15.0 mm, a width of 12.0 mm and a thickness of 0.80 mm, while the third partial piece preferably has a length of 25.0 mm, a width of 15.0 mm and a thickness of 0.80 mm. The first partial piece preferably has a length of 12.30 mm, a width of 8.80 mm and a thickness of 0.67 mm, and the data carrier body has a length of 85.60 mm, a width of 53.98 mm and a thickness of 0.80 mm. All dimensions are to be understood to include a tolerance of +/−0.1 mm.

Preferably thus standard-compliant form factors are provided, wherein the data carrier is preferably a chip card in the ID-1 format according to ISO/IEC 7810:2003 and in the first partial piece is a nano SIM (4FF) according to ETSI TS 102 221 V11.0.0. The second partial piece is preferably a micro SIM (mini UICC; 3FF) according to ETSI TS 102 221 V9.0.0 and the third partial piece is a mini SIM (UICC; ID-000; 2FF) according to ISO/IEC 7810:2003. Preferably, the data carrier has all four form factors. The second and/or third partial piece can also be omitted, however. In another expedient variant, the data carrier itself has the shape of a third partial piece and includes a second and/or a first partial piece; the partial piece forming the largest form factor is missing here.

The cutting through of the data carrier body for producing the first partial piece and, optionally, producing the second and/or third partial piece detachable from the data carrier body is preferably effected by punching. Therein the partial pieces can be fitted into each other accurately or a gap can be provided, wherein the partial pieces are then interconnected by webs. Preferably, smaller form factors are punched first, in other words the punching takes place from the inside towards the outside, since this facilitates the handling and the meeting of tolerances.

The invention is described hereinafter by way of example with reference to the accompanying schematic drawings. The figures are described as follows:

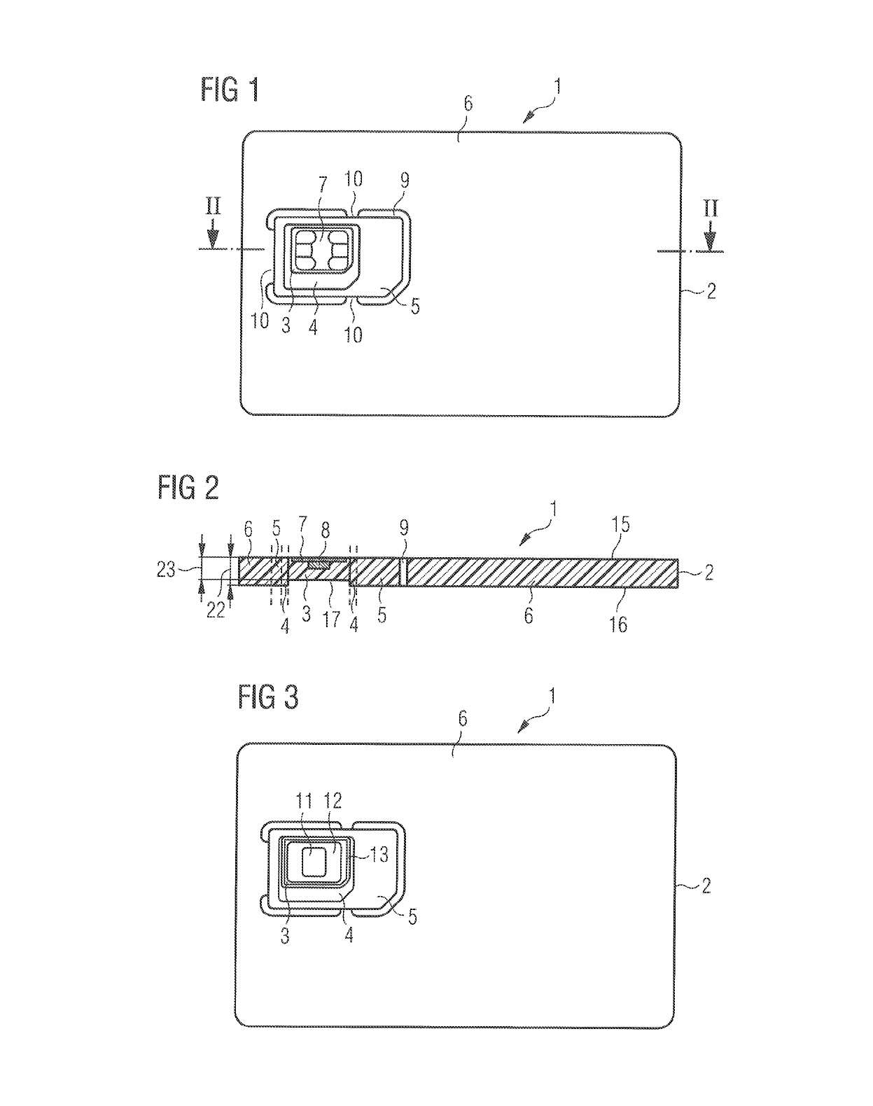

FIG. 1 a data carrier in the form of a chip card in plan view,

FIG. 2 a section through the data carrier of FIG. 1,

FIG. 3 a plan view of the data carrier of FIG. 1 without the chip module and

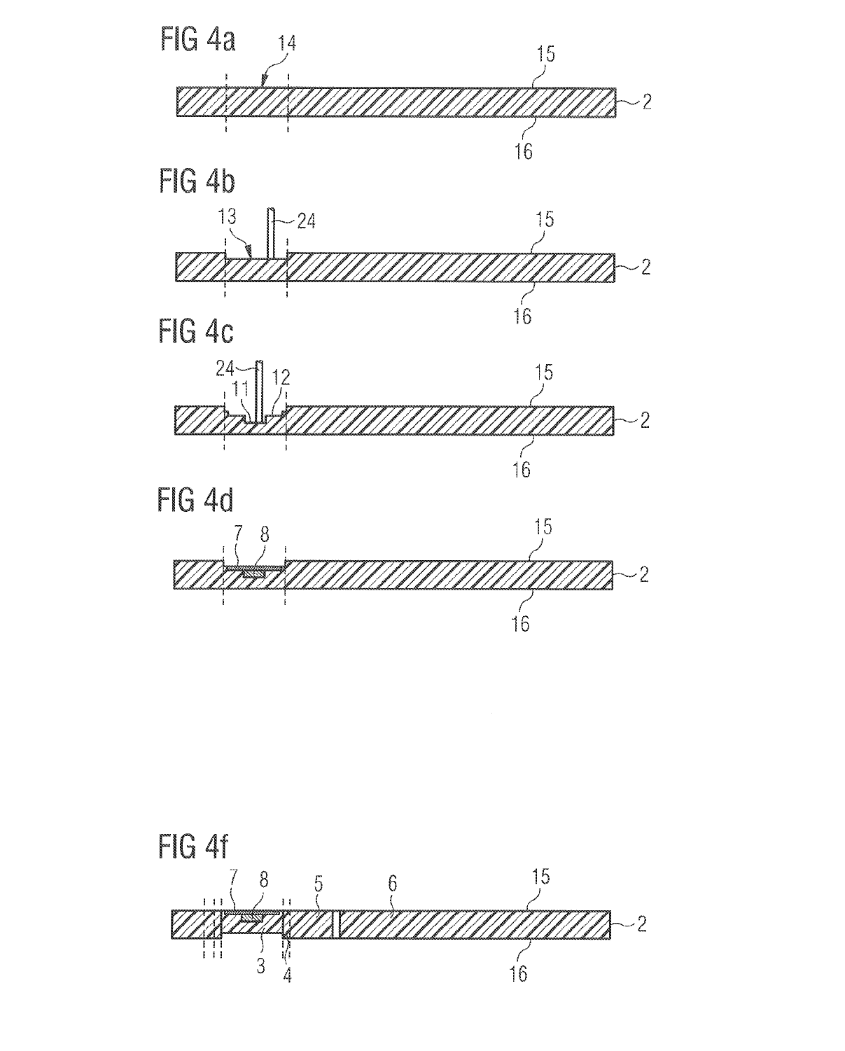

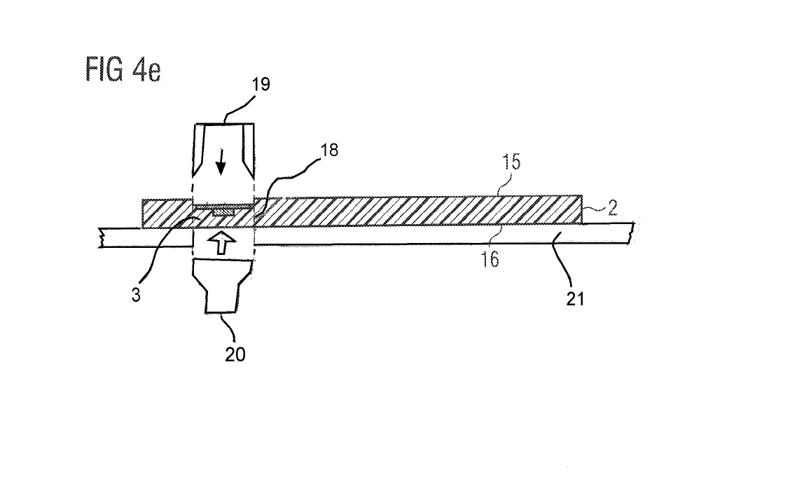

FIGS. 4a to 4f selected method steps for manufacturing the data carrier of FIG. 1 in a schematic sectional representation.

In FIG. 1, a data carrier 1 is shown in the form of a chip card, the body 2 of which comprises a plurality of partial pieces 3, 4, 5, 6. The data carrier body 2 is preferably made of injection-molded ABS (acrylonitrile butadiene styrene), but can also be manufactured in different fashion and/or of different materials, for example by laminating a plurality of layers. The present exemplary embodiment is a combination SIM card in which the partial pieces 3, 4, 5, 6 form standardized form factors. The data carrier 1 is a full-size SIM card 6 in the ID-1 format according ISO/IEC 7810:2003. The first partial piece 3 in the exemplary embodiment is a nano SIM (4FF) according to ETSI TS 102 221 V11.0.0. The second partial piece 4 is a micro SIM (mini UICC; 3FF) according to ETSI TS 102 221 V9.0.0, and the third partial piece 5 a mini SIM (UICC; ID-000; 2FF) according to ISO/IEC 7810:2003.

The third partial piece 5 can be taken out of the card body 2 and for this purpose is connected to said card body by webs 10 with predetermined breaking points, wherein a gap 9 is provided between the third partial piece 5 and the remaining card body 2, said gap being produced by means of a corresponding punching tool. The nano SIM 3, the micro SIM 4 and the mini SIM 5 are respectively fitted into each other. In other words, the respectively larger form factor comprises a through opening into which the respectively smaller form factor is fitted. A user can detach the form factor matching his terminal from the card body 2. Advantageously, a detached smaller form factor can be refitted into the corresponding through hole of the next larger form factor, if an undersized form factor has been detached accidentally, for example. Advantageously, in particular a partial piece 3 can be reinserted into a partial piece 4, and a partial piece 4 into a partial piece 5.

The first partial piece 3 in the form of the nano SIM has a chip module with a chip 8 and contact areas 7. As can be seen in the sectional view in FIG. 2, the surface of the first partial piece 3, in particular the contact areas 7 of the chip module, are flush with the front side 15 of the chip card 1.

According to specification, however, it is permissible for the surface of the chip module to be offset from the front side of the chip card 1 by +/−0.1 mm. In contrast, on the back side 16 a depression 17 can be found in the region of the first partial piece 3, since the first partial piece 3 has been displaced in the direction of the front side 15 after punching, as will be described in detail below. The first partial piece 3 hence has a thickness 23 that is reduced with reference to the thickness 22 of the other form factors. The first thickness 22 amounts to 0.68 mm to 0.84 mm, preferably 0.80 mm, while the second thickness 23 is smaller, and amounts to 0.60 mm to 0.70 mm, preferably 0.64 mm. In FIG. 2 the boundaries of the partial pieces 3, 4, 5 are indicated by dashed lines.

In FIG. 3 a top view is shown of a card body 2 after the reduction of the thickness, wherein also the two-tier cavity 11, 12 for the chip module 7, 8 is shown, with the chip module 7, 8 itself being omitted for the sake of clarity, however. In practice, the chip module 7, 8 is expediently inserted into the cavity 11, 12 before the partial pieces 3, 4, 5 are prepared. The cavity 12 in this exemplary embodiment has slightly smaller length and width dimensions than the first partial piece 3, but can also take up the entire area of the partial piece 3. Moreover, a depression 13 can be seen on the front side, said depression having been produced in order to reduce the thickness 22 of the card body 2 to the desired thickness 23 of the first partial piece 3. As can be seen in FIG. 2, the depression 13 can slightly exceed the dimensions of the first partial piece 3. Preferably (as presumed in FIGS. 2 and 4a-4f), the thickness 22 of the card body 2 is reduced exactly in that region which corresponds to the dimensions of the first partial piece 3, i.e. the depression 13 (and thus the predetermined region 14, see FIG. 4a) and the first partial piece 3 are congruent. The reduction of the thickness 22 of the card body 2 and the production of the cavity 11, 12 is preferably effected by milling the card body 2. Other methods for removing the material of the card body 2 are likewise conceivable, such as lasering.

In FIGS. 4a to 4f method steps of a method for manufacturing a chip card 1 with a partial piece 3 are represented, said partial piece having a thickness 23 that is reduced in relation to the rest of the card body 2. In FIG. 4a, a blank of a card body 2 is represented with a front side 15 and a front side 16. The front side 15 and the back side 16 have already been printed in a preceding step. A predetermined region 14 is indicated, in which the thickness of the card body 2 is to be reduced. As already explained, the dimensions of the predetermined region preferably correspond to those of the first partial piece 3 to be produced.

As shown in FIG. 4b, a depression 13 is milled by means of a milling tool 24 in the predetermined region 14 on the front side 15 of the card body 2 that is preferably already printed on both sides, in order to reduce the thickness 22 of the card body 2 to the desired thickness 23 of the partial piece 3 to be produced. The print is destroyed in this region on the front side, which does not impair the appearance of the final product however, since in this place a chip module 7, 8 is inserted, the contact areas 7 of which can cover the front side of the partial piece 3 almost entirely or entirely. For this purpose, a cavity 11, 12 is milled which is, for example, of a two-tier configuration, in order to receive the chip module with the contact areas 7 and the chip 8 correspondingly (FIG. 4c). Said chip module is implanted in the cavity 11, 12 according to known methods (FIG. 4d).

FIG. 4e shows the step of producing the first partial piece 3 with the aid of a punching tool 19 and a punch 20. The card body 2 is expediently resting on a matrix 21. The punching is effected with the punching tool 19 from the front side 15 of the card body 2. The produced partial piece 3 is displaced in the direction of the front side 15 of the card body in the through opening 18 created upon punching. This is effected by means of the punch 20. During the withdrawal of the punching tool 19 further the partial piece 3 is adjusted to the front side 15 of the card body 2 with the aid of the punch 20 in the same method step. The first partial piece 3 can thus be aligned to be flush with the front side 15 of the card body 2, wherein at the same time a depression 17 is created on the back side. In particular, then also the contact areas 7 of the chip module are aligned to be flush with the front side 15 of the card body 2.

In FIG. 4f finally the end product is represented analogously to FIG. 2, wherein, after producing the first partial piece 3, further partial pieces 4, 5 have been produced consecutively in corresponding fashion. The partial pieces are preferably produced from the inside to the outside, i.e. smaller partial pieces are produced first. A simultaneous punching of all partial pieces 3, 4, 5 is possible as well. The front side of the chip card 1 is level, so that contacts of a terminal, such as a mobile phone, cannot get stuck in a depression. At the same time, the printing of the back side 16 remains intact in the region of the first partial piece 3, since the thickness 22 of the card body 2 is reduced from the front side, and is only slightly pushed into the card body 2 together with the first partial piece 3 after the punching process.

1-15. (canceled)

16. A method for manufacturing a data carrier, in particular a chip card, comprising the steps of:
making available a card-shaped data carrier body with a first thickness and a front side and a back side,
reducing the first thickness of the data carrier body to a second thickness in a predetermined region on the front side of the data carrier body and
cutting through the data carrier body in the predetermined region for producing a first partial piece of the data carrier body, so that the first partial piece is fitted into a through opening of the data carrier body created by the cutting through and is displaceable in the through opening,
wherein the step of displacing the first partial piece within the through opening in the direction of the front side of the data carrier body, so that the first partial piece is flush with the front side of the data carrier body.

17. The method according to claim 16, wherein the step of printing at least the back side of the data carrier body before the step of reducing the first thickness of the data carrier body in the predetermined region.

18. The method according to claim 16, wherein the step of printing of the front side of the data carrier body before the step of reducing the first thickness of the data carrier body in the predetermined region.

19. The method according to claim 16, wherein the step of cutting through the data carrier body for producing the first partial piece is effected from the back side of the data carrier body, wherein the front side of the data carrier body lies against a flat surface and the first partial piece is pushed against the flat surface for flush alignment with the front side of the data carrier body.

20. The method according to claim 16, wherein the step of producing a cavity for a chip module on the front side of the data carrier body in the predetermined region and of inserting a chip module into the cavity, preferably prior to displacing the first partial piece in the direction of the front side of the data carrier body.

21. The method according to claim 16, wherein the step of reducing the first thickness of the data carrier body in the predetermined region is effected by milling the front side of the data carrier body.

22. The method according to claim 16, wherein the second thickness amounts to at least 70%.

23. The method according to claim 16, wherein the step of producing at least one second partial piece detachable from the data carrier body, said second partial piece enclosing the first partial piece, wherein the second partial piece preferably has a length of 15.00 mm, a width of 12.0 mm and a thickness of 0.80 mm,
and/or a third partial piece detachable from the data carrier body, said third partial piece enclosing the first partial piece and, where applicable, the second partial piece, wherein the third partial piece preferably has a length of 25.0 mm, a width of 15.0 mm and a thickness of 0.80 mm.

24. The method according to claim 16, wherein the first partial piece is produced having a length of 12.30 mm, a width of 8.8 mm and a thickness of 0.64 mm and/or the data carrier body has a length of 85.6 mm, a width of 53.98 mm and a thickness of 0.80 mm.

25. The method according to claim 16, wherein the step of cutting through the data carrier body for producing the first partial piece and, where applicable, the step of producing the second and/or third partial piece detachable from the data carrier body is effected by punching.

26. A data carrier, in particular a chip card, comprising a card-shaped data carrier body with a first thickness and a front side and a back side, wherein the data carrier has at least one partial piece which is separated from the rest of the data carrier body and is fitted into a through opening of the data carrier body and is displaceable in the through opening, wherein the first partial piece has a second thickness that is reduced in relation to the first thickness, wherein the first partial piece is arranged in the through opening of the data carrier body such that it is flush with the front side of the data carrier body.

27. The data carrier according to claim 26, wherein the data carrier has a chip module which is inserted into the first partial piece.

28. The data carrier according to claim 26, wherein the second thickness amounts to at least 70%.

29. The data carrier according to claim 26, wherein the data carrier body has at least one second partial piece detachable from the data carrier body, said second partial piece enclosing the first partial piece, wherein the second partial piece preferably has a length of 15.0 mm, a width of 12.0 mm and a thickness of 0.80 mm,
and/or a third partial piece detachable from the data carrier body, said third partial piece enclosing the first partial piece and, where applicable, the second partial piece, wherein the third partial piece preferably has a length of 25.0 mm, a width of 15.0 mm and a thickness of 0.80 mm.

30. The data carrier according to claim 26, wherein the first partial piece has a length of 12.30 mm, a width of 8.8 mm and a thickness of 0.64 mm and/or the data carrier body has a length of 85.6 mm, a width of 53.98 mm and a thickness of 0.80 mm.
